(19) United States
(12) Patent Application Publication
(10) Pub. No.: US 2026/0108812 A1
(43) Pub. Date: Apr. 23, 2026

(54) VIRTUAL MAP DISPLAY CONTROL METHOD AND APPARATUS, COMPUTER DEVICE, READABLE STORAGE MEDIUM, AND PROGRAM PRODUCT

(71) Applicant: Shanghai Ning Yu Network Technology Co., Ltd., Shanghai (CN)

(72) Inventors: Zhiyi ZHANG, Shanghai (CN); Kejie RUAN, Shanghai (CN); Yingman ZHANG, Shanghai (CN); Fangshu MO, Shanghai (CN); Qingyu WANG, Shanghai (CN); Xingyu MA, Shanghai (CN)

(73) Assignee: Shanghai Ning Yu Network Technology Co., Ltd., Shanghai (CN)

(21) Appl. No.: 19/165,537

(22) PCT Filed: May 29, 2025
(86) PCT No.: PCT/CN2025/097935

§ 371 Date: Sep. 15, 2025

(30) Foreign Application Priority Data
Oct. 10, 2024 (CN) 202411409312.8

(51) Int. Cl. A63F 13/5378; A63F 13/79

(52) U.S. Cl. CPC A63F 13/5378; A63F 13/79

(57) ABSTRACT

The present disclosure relates to a display control method and apparatus for a virtual map, a computer device, a readable storage medium and a program product. Upon receiving a configuration operation on the first map region in the virtual map, a target camp corresponding to the configuration operation is determined and coloring information of the target camp is obtained. The region to be colored of the target camp in the first map region is determined based on the configuration operation, and the region to be colored of the target camp in the first map region is rendered and displayed based on the coloring information.

### CROSS-REFERENCE TO RELATED DISCLOSURES

This application is an U.S. national stage application of PCT international application No. PCT/CN2025/097935 filed on May 29, 2025, which claims priority to Chinese patent application No. 2024114093128, filed on Oct. 10, 2024, the entire contents of which are incorporated herein by reference.

### TECHNICAL FIELD

The present disclosure relates to the field of game display technologies, and in particular, to a display control method and apparatus for a virtual map, a computer device, a readable storage medium and a program product.

### BACKGROUND

With the development of Internet technology, video games have become an important part of people's leisure and entertainment. In order to provide users with a better gaming experience, a virtual map, i.e., a game map, is typically provided in the game. Users can use the game map to select optimal strategic positions, control points, etc., to increase the chances of winning the game.

### SUMMARY

In a first aspect, the present disclosure provides a display control method for a virtual map. The virtual map is configured with at least two camps and a plurality of map regions corresponding to a virtual game scene, and the method includes:
upon receiving a configuration operation on a first map region in the virtual map, determining a target camp corresponding to the configuration operation, and obtaining coloring information of the target camp;
determining a region to be colored of the target camp in the first map region based on the configuration operation; and
rendering and displaying the region to be colored of the target camp in the first map region based on the coloring information.

In an embodiment, the configuration operation is configured to configure a virtual object to the first map region, and after the configuration operation on the first map region in the virtual map is received, the method further includes: when it is determined that the target camp corresponding to the configuration operation has a historical configuration operation on the first map region, determining a number of historical accumulated virtual objects and a historical accumulated colored region corresponding to the historical configuration operation; and rendering and displaying the region to be colored of the target camp in the first map region based on the coloring information includes: when it is determined that the number of the historical accumulated virtual objects does not reach a preset number threshold, rendering and displaying the historical accumulated colored region and the region to be colored in the first map region based on the coloring information of the target camp.

In an embodiment, the method further includes: when it is determined that the number of the historical accumulated virtual objects reaches the preset number threshold, rendering and displaying the historical accumulated colored region in the first map region based on the coloring information of the target camp.

In an embodiment, the method further includes: responding to an interactive operation on a second map region in the virtual map performed by at least one camp controlled by a user, the interaction operation being configured to obtain ownership of the second map region; determining a target camp that has ownership of the second map region based on a result of the interactive operation; and rendering and displaying the second map region based on the coloring information corresponding to the target camp.

In an embodiment, the second map region includes a colored region corresponding to at least one camp, and before responding to the interactive operation on the second map region in the virtual map performed by the at least one camp controlled by the user, the method further includes: displaying a first attribute value of the camp corresponding to the colored region; and after responding to the interactive operation on the second map region in the virtual map performed by the at least one camp controlled by the user, the method further includes: determining and displaying a second attribute value of the camp based on the interactive operation; and when it is determined that the second attribute value of the camp is less than the corresponding first attribute value, decreasing an area of the colored region corresponding to the camp.

In an embodiment, each of the map regions is displayed with corresponding region information, and rendering and displaying the region to be colored of the target camp in the first map region based on the coloring information includes: determining a first display position of the corresponding region information in the first map region; determining a second display position corresponding to the target camp in the first map region based on the first display position, the second display position and the first display position doing not overlap each other; and rendering and displaying the region to be colored of the target camp based on the coloring information at the second display position in the first map region.

In a second aspect, the present disclosure further provides a display control apparatus for a virtual map. The virtual map is configured with at least two camps and a plurality of map regions corresponding to a virtual game scene, and the apparatus includes:
a coloring information determination module configured to determine, upon receiving a configuration operation on a first map region in the virtual map, a target camp corresponding to the configuration operation, and obtain coloring information of the target camp;
a region determination module configured to determine a region to be colored of the target camp in the first map region based on the configuration operation; and
a rendering and display module configured to render and display the region to be colored of the target camp in the first map region based on the coloring information.

In a third aspect, the present disclosure further provides a computer device including a memory and a processor. The memory stores a computer program. The processor, when executing the computer program, implements steps of the method described in the first aspect.

In a fourth aspect, the present disclosure further provides a non-transitory computer-readable storage medium having a computer program stored thereon. When the computer program is executed by a processor, steps of the method described in the first aspect are implemented.

In a fifth aspect, the present disclosure further provides a computer program product including a computer program, wherein when the computer program is executed by a processor, steps of the method described in the first aspect are implemented.

### BRIEF DESCRIPTION OF THE DRAWINGS

In order to describe the technical solutions of the embodiments of the present disclosure or the related art more clearly, the accompanying drawings required for describing the embodiments of the present disclosure or for describing the related art will be briefly introduced as follows. Apparently, the accompanying drawings, in the following description, illustrate merely some embodiments of the present disclosure, for a person of ordinary skill in the art, other drawings can also be obtained according to these accompanying drawings without making any creative efforts.

FIG. 1 is a schematic diagram of a virtual map in an embodiment.

FIG. 2 is a schematic flow chart of a display control method for a virtual map in an embodiment.

FIG. 3 is a schematic diagram of a virtual map in another embodiment.

FIG. 4 is a schematic diagram of a display based on a configuration operation in an embodiment.

FIG. 5 is a schematic flow chart of an interactive display in an embodiment.

FIG. 6 is a schematic diagram of a virtual map in yet another embodiment.

FIG. 7 is a schematic diagram of a display based on ownership in an embodiment.

FIG. 8 is a schematic flow chart of an interactive display in another embodiment.

FIG. 9 is a schematic diagram of a display of attribute values in an embodiment.

FIG. 10 is a schematic diagram of a display based on interactive operations in an embodiment.

FIG. 11 is a block diagram of a structure of a display control apparatus for a virtual map in an embodiment.

FIG. 12 is a diagram of an internal structure of a computer device in an embodiment.

### DETAILED DESCRIPTION OF THE EMBODIMENTS

In order to make the objectives, technical solutions and advantages of the present disclosure more clearly understood, the present disclosure will be further described in detail with the accompanying drawings and embodiments. It should be understood that the specific embodiments described herein are only used to explain the present disclosure and not to limit the present disclosure.

It should be noted that the terms “first”, “second”, etc. in the specification and claims of the present disclosure and the above-mentioned drawings are used to distinguish similar objects, and are not necessarily used to describe a specific order or sequence. It should be understood that the terms used here are interchangeable under appropriate circumstances such that the embodiments of the present disclosure described herein can be implemented in an order other than those illustrated or described herein. The implementations described in the following exemplary embodiments do not represent all implementations consistent with the present disclosure. Rather, they are merely examples of apparatus and methods consistent with some aspects of the present disclosure as detailed in the appended claims. The terms “including”, “comprising” or any other variations thereof are intended to cover non-exclusive inclusion, such that a process, method, product, or apparatus that includes a list of elements includes not only those elements but also other elements not expressly listed, or further includes elements inherent to such a process, method, product, or apparatus. Without further limitations, it does not exclude the existence of other identical or equivalent elements in the process, method, product or device including the elements. For example, if the terms “first”, “second”, etc. are used, they are used to indicate names and do not indicate any particular order.

In the conventional art, territories belonging to different organizations or players in the game map are generally marked as different map regions to distinguish the territories of different organizations or players. However, since the game map is generally displayed statically, it lacks dynamism and interactivity, making the gameplay monotonous and boring, and diminishing the player's gaming experience.

In an embodiment, the present disclosure provides a display control method for a virtual map. It can be understood that the method can be applied to a terminal device, a server, or a system including a terminal device and a server, and can be implemented through the interaction between the terminal device and the server.

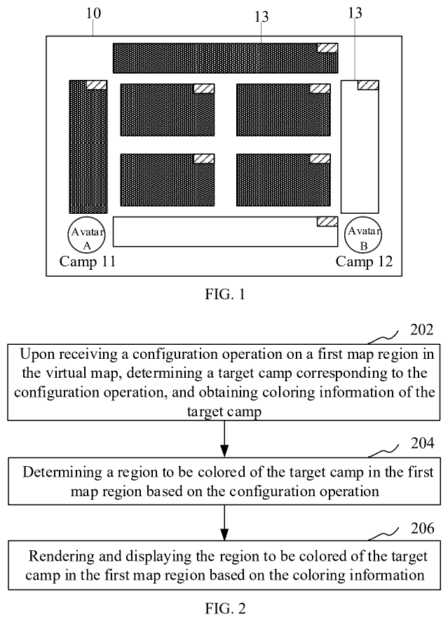

In an exemplary embodiment, the method is described by taking its application to a terminal device as an example. Specifically, the terminal device is capable of running a game application and displaying a game interface corresponding to a virtual game scene. As shown in FIG. 1, the virtual game scene at least displays a virtual map 10, and the virtual map 10 includes at least two camps (such as camp 11 and camp 12) corresponding to the virtual game scene and a plurality of map regions 13 (FIG. 1 shows 8 map regions 13 as an example). The camp is an important form of organization in the game, allowing like-minded players to gather together and participate in various activities and challenges, while different camps can engage in competitive activities. For example, camps can be guilds in a guild war (Group vs Group), and camp 11 and camp 12 are different guilds.

In the present embodiment, as shown in FIG. 2, the method may include the following steps.

In the step 202, upon receiving a configuration operation on a first map region in the virtual map, a target camp corresponding to the configuration operation is determined, and coloring information of the target camp is obtained.

The first map region can be a map region among the plurality of map regions on which each camp can perform a configuration operation, i.e., a map region on which each camp has a configuration operation permission. In this embodiment, in order to improve the user experience, the map region where the camp has the configuration operation permission and the map region where the camp does not have the configuration operation permission can be displayed in the virtual map in different forms (such as color, shape, etc.). For example, in FIG. 1, the map region where the camp has the configuration operation permission, i.e., the first map region, is displayed in white (such as the rightmost map region and the bottom map region in FIG. 1), and the map region where the camp does not have the configuration operation permission is displayed in black.

The configuration operation may be an operation taken by a player to configure virtual objects such as troops and weapons in the first map region based on the virtual game scene. The target camp is the camp to which the player currently performing the configuration operation on the first map region belongs. The coloring information may be specific color information, such as red, orange, yellow, green, blue, etc. Since color is composed of three primary colors, namely red, green, and blue, and the light of these three primary colors can be combined in different proportions to produce a variety of colors of lights, the coloring information may also be specific RGB (red, green, blue) values, HSL (hue, saturation, lightness) values, HSB (hue, saturation, brightness) values, etc. In this embodiment, in order to improve the display effect and user experience, different camps can have different coloring information, which can be allocated by the game application running in the terminal device when the camp is generated, or can be configured by the corresponding player, which is not limited thereto in this embodiment.

In this embodiment, players from the respective camps can each perform the configuration operation on the first map region in the virtual map. Upon receiving the configuration operation on the first map region in the virtual map, the terminal device can determine the target camp to which the player corresponding to the configuration operation belongs, and obtain the coloring information of the target camp.

In the step 204, a region to be colored of the target camp in the first map region is determined based on the configuration operation.

The region to be colored may be a region that needs to be colored determined based on the configuration operation. Since the configuration operation is the operation taken by the player to configure virtual objects such as troops and weapons in the first map region based on the virtual game scene, the region to be colored of the target camp to which the player corresponding to the configuration operation belongs in the first map region can be determined based on the configuration operation. It can be understood that the size of the region to be colored can be determined based on the number of the virtual objects such as troops and weapons deployed by the target camp in the first map region. For example, the more virtual objects deployed by the target camp, the larger the corresponding region to be colored.

In the step 206, the region to be colored of the target camp in the first map region is rendered and displayed based on the coloring information.

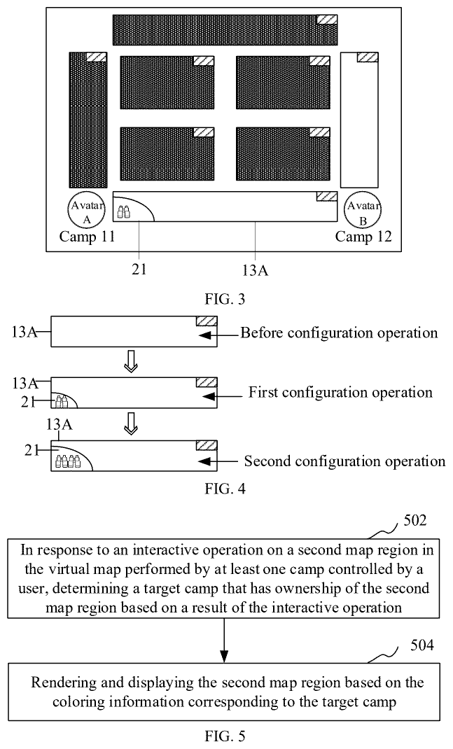

Specifically, the terminal device can render the region to be colored of the target camp in the first map region based on the coloring information of the target camp obtained as described above, so as to obtain and display the corresponding colored region. Specifically, as shown in FIG. 3, if the coloring information of the camp 11 is yellow, the terminal device can determine the region to be colored of the camp 11 in the first map region based on the configuration operation of the camp 11 on the first map region 13A, and render the corresponding region to be colored based on the coloring information of the camp 11 to obtain and display the colored region 21. It can be understood that the colored region 21 can be displayed in yellow, so that the players can intuitively know the configuration of their camp in the first map region, thereby improving the dynamic display performance of the virtual map.

In the display control method for a virtual map as described above, upon receiving the configuration operation on the first map region in the virtual map, the terminal device determines the target camp corresponding to the configuration operation and obtains the coloring information of the target camp. The region to be colored of the target camp in the first map region is determined based on the configuration operation, and the region to be colored of the target camp in the first map region is rendered and displayed based on the coloring information, so that the players can intuitively know the configuration of their camp in the first map region, thereby improving the dynamic display performance of the virtual map. In addition, since the region to be colored is dynamically determined based on the corresponding configuration operation, a better dynamic interactive experience is provided.

In an exemplary embodiment, in the step 202, after the configuration operation on the first map region in the virtual map is received, the above method may further include: when it is determined that the target camp corresponding to the configuration operation has a historical configuration operation on the first map region, determining a number of historical accumulated virtual objects and a historical accumulated colored region corresponding to the historical configuration operation.

The historical configuration operation is relative to the currently received configuration operation, and refers to a configuration operation performed on the same first map region by the same target camp as the current configuration operation before the current configuration operation. For example, if the current configuration operation is an operation in which the camp 11 configures a virtual object (such as troop, weapon, etc.) on the first map region 13A, then the historical configuration operation is an operation in which the camp 11 has configured the virtual object (such as troop, weapon, etc.) on the first map region 13A before the current configuration operation. The number of the historical accumulated virtual objects is a number of configured virtual objects corresponding to the historical configuration operation. It can be understood that each configuration operation has a corresponding number of virtual objects that need to be configured. The historical accumulated colored region is an accumulated colored region corresponding to the historical configuration operation. Specifically, upon receiving the configuration operation on the first map region in the virtual map, the terminal device further determines whether the target camp corresponding to the configuration operation has a historical configuration operation on the first map region. If it is determined that the target camp corresponding to the configuration operation has a historical configuration operation on the first map region, the terminal device further determines the number of the historical accumulated virtual objects and the historical accumulated coloring region corresponding to the historical configuration operation.

Then in the step 206, rendering and displaying the region to be colored of the target camp in the first map region based on the coloring information may specifically include: when it is determined that the number of the historical accumulated virtual objects does not reach a preset number threshold, rendering and displaying the historical accumulated colored region and the region to be colored in the first map region based on the coloring information of the target camp; and when it is determined that the number of the historical accumulated virtual objects reaches the preset number threshold, rendering and displaying the historical accumulated colored region in the first map region based on the coloring information of the target camp.

The preset number threshold may be a preset maximum number of virtual objects that each camp can configure for the first map region. If it is determined that the number of the historical accumulated virtual objects does not reach the preset number threshold, the historical accumulated colored region and the region to be colored in the first map region are rendered and displayed based on the coloring information of the target camp, i.e., the region to be colored corresponding to the current configuration operation is added to the historical accumulated colored region for rendering and display. In other words, based on the increase in the number of the virtual objects configured by the target camp in the first map region, an area of the colored region of the target camp in the first map region is gradually expanded. Specifically, as shown in FIG. 4, as the number of the virtual objects configured by the camp 11 in the first map region 13A increases, the area of the colored region 21 of the camp 11 in the first map region 13A is gradually expanded, thereby further improving the dynamic display performance of the virtual map and improving the user experience.

When it is determined that the number of the historical accumulated virtual objects reaches the preset number threshold, the historical accumulated colored region in the first map region may be rendered and displayed based on the coloring information of the target camp. In other words, when the number of the virtual objects configured by the target camp in the first map region reaches the maximum number, the area of the colored region of the target camp in the first map region will also reach a maximum value and will not expand any further, allowing different camps to configure virtual objects in the same first map region, thereby increasing the playability of the game and improving the user's gaming experience.

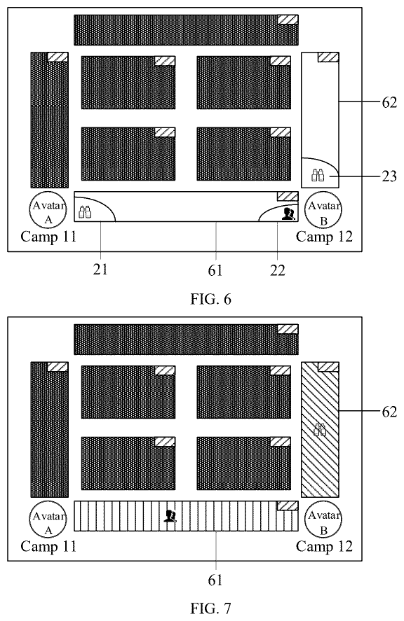

In an exemplary embodiment, as shown in FIG. 5, in the step 206, after rendering and displaying the region to be colored of the target camp in the first map region based on the coloring information, the method may further include the following steps.

In the step 502, in response to an interactive operation on a second map region in the virtual map performed by at least one camp controlled by a user, a target camp that has ownership of the second map region is determined based on a result of the interactive operation.

The second map region is a map region to which virtual objects have been allocated by at least one camp. Therefore, the second map region includes a colored region corresponding to at least one camp. Since different camps have different corresponding coloring information, the colored regions corresponding to different camps can be displayed in different colors. Specifically, as shown in FIG. 6, if the coloring information of the camp 11 is yellow, the coloring information of the camp 12 is blue, the camp 11 has allocated virtual objects to both the second map region 61 and the second map region 62, and the camp 12 has also allocated virtual objects to the second map region 61, then in the second map region 61, the colored region 21 corresponding to the camp 11 can be displayed in yellow, and the colored region 22 corresponding to the camp 12 can be displayed in blue. In the second map region 62, the colored region 23 corresponding to the camp 11 can also be displayed in yellow. In this way, the configuration of each camp in the map region can be displayed intuitively.

The interactive operation is an operation for obtaining ownership of the second map region, which may specifically be an attack operation between users in different camps who have allocated virtual objects to the same second map region. It can be understood that in a game scene, different players may have different roles, and different roles may have different operation permissions in the game. In this embodiment, the user who controls at least one camp to perform the interactive operation on the second map region in the virtual map can be any player in the camp who has the permission to perform an interactive operation on the second map region in the virtual map. For example, in a GVG (Group vs Group, i.e., online game team growth mode) game scene, each camp is considered to be a guild (Group). Generally, only the guild leader of each camp has the permission to perform an interactive operation on the second map region in the virtual map. For example, as shown in FIG. 6, the interactive operation may be an attack operation between the user in the camp 11 and the user in the camp 12 who have allocated virtual objects to the second map region 61, and the ownership of the second map region 61 is obtained by defeating the opponent through the attack. The result of the interactive operation includes obtaining the ownership of the second map region and failing to obtain the ownership of the second map region. Therefore, based on the result of the interactive operation, it can be determined which camp the ownership of the second map region belongs to, i.e., the target camp is determined.

In the step 504, the second map region is rendered and displayed based on the coloring information corresponding to the target camp.

Since the target camp is the camp that has the ownership of the second map region determined in the above steps, the terminal device can render and display the second map region based on the coloring information corresponding to the target camp. Specifically, as shown in FIG. 7, based on FIG. 6, if it is determined that the target camp that has the ownership of the second map region 61 is the camp 12, the second map region 61 is rendered and displayed based on the coloring information of the camp 12, i.e., blue. If it is determined that the target camp that has the ownership of the second map region 62 is the camp 11, and the second map region 62 is rendered and displayed based on the coloring information of the camp 11, i.e., yellow. In this way, the region occupied by each camp in the virtual map can be displayed intuitively.

In the above embodiment, for the second map region to which the virtual objects have been allocated by the at least one camp, in response to the interactive operation on the second map region in the virtual map performed by the at least one camp controlled by the user, the terminal device can determine the target camp that has the ownership of the second map region based on the result of the interactive operation, and then render and display the second map region based on the coloring information corresponding to the target camp. In the game mechanism, this interactive dynamic process makes the game more vivid and interesting, increasing the interactivity of the game. In addition, through the coloring information of different camps, the map regions owned by each camp are rendered and displayed intuitively, allowing players to easily identify the progress of the game, i.e., identifying which camp occupies which map region, thereby improving the user experience and gaming enjoyment.

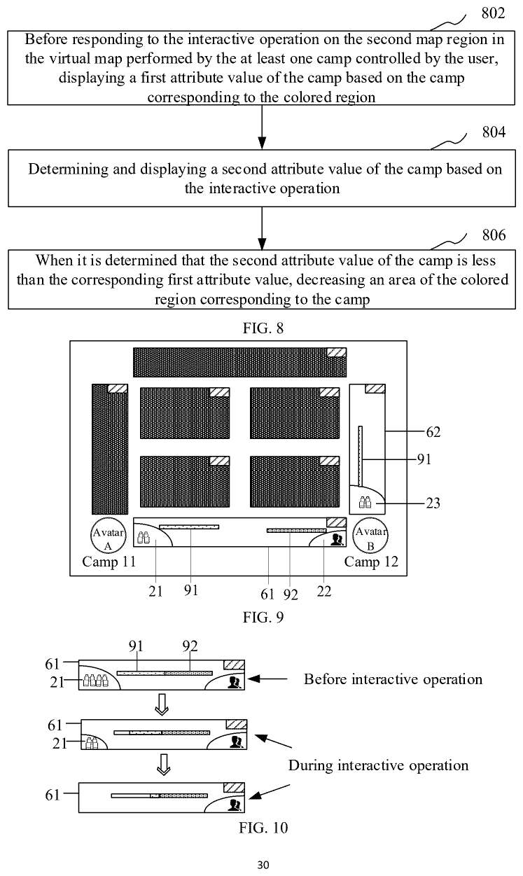

In an exemplary embodiment, as shown in FIG. 8, the method may further include the following steps.

In the step 802, before responding to the interactive operation on the second map region in the virtual map performed by the at least one camp controlled by the user, a first attribute value of the camp is displayed based on the camp corresponding to the colored region.

The first attribute value may be an initial energy value or initial health value of the corresponding camp, which can be specifically identified by a graphical interface element. Specifically, as shown in FIG. 9, based on FIG. 6, the first attribute value of the camp 11 can be identified by a yellow progress bar 91, and the first attribute value of the camp 12 can be identified by a blue progress bar 92. In FIG. 9, the terminal device can display the first attribute value of each camp based on the camp corresponding to the colored region.

In the step 804, a second attribute value of the camp is determined and displayed based on the interactive operation.

The second attribute value is obtained by updating the first attribute value of each camp based on the interactive operation after the terminal device responds to the interactive operation on the second map region in the virtual map performed by the at least one camp controlled by the user. Since the interactive operation is an operation for obtaining the ownership of the second map region, and the interactive operation may specifically be an attack operation between players in different camps who have allocated virtual objects to the same second map region, the terminal device may update the first attribute value of each camp according to the attack situation of each attack operation to obtain the second attribute value. As shown in FIG. 10, if the user in the camp 12 who has allocated virtual objects to the second map region 61 initiates an interactive operation with the user in the camp 11, the virtual objects allocated by the camp 12 in the second map region 61 can attack the virtual objects allocated by the camp 11. If the number of the virtual objects corresponding to the camp 11 decreases during the attack, the corresponding first attribute value will also decrease, thereby updating the first attribute value corresponding to the camp 11 and displaying the updated second attribute value.

In the step 806, when it is determined that the second attribute value of the camp is less than the corresponding first attribute value, an area of the colored region corresponding to the camp is decreased.

Since the area of the colored region of each camp in the map region is determined according to the number of virtual objects allocated by each camp in the map region, and the attribute value of each camp varies accordingly as the number of virtual objects of the corresponding camp in the map region decreases, when it is determined that the second attribute value of a camp is less than the corresponding first attribute value, it means that the number of virtual objects of the camp in the map region has decreased, and thus the area of the colored region corresponding to the camp is decreased accordingly, thereby achieving an intuitive display of the game process, and further improving the user experience and enhancing user participation.

For example, as shown in FIG. 10, before the interactive operation, the first attribute values of the respective camps are equivalent. During the interactive operation, as the virtual objects corresponding to the camp 12 in the second map region 61 attacks the virtual objects corresponding to the camp 11, the number of the virtual objects corresponding to the camp 11 gradually decreases, and the attribute value corresponding to the camp 11 also gradually decreases. Correspondingly, the area of the colored region 21 corresponding to the camp 11 also gradually decreases, until the area of the colored region 21 corresponding to the camp 11 decreases to zero, and then the result of the corresponding interactive operation can be determined, i.e., the ownership of the second map region is obtained.

In an exemplary embodiment, each of the map regions is displayed with corresponding region information. In the step 206, rendering and displaying the region to be colored of the target camp in the first map region based on the coloring information may specifically include: determining a first display position of the corresponding region information in the first map region; determining a second display position corresponding to the target camp in the first map region based on the first display position; and rendering and displaying the region to be colored of the target camp based on the coloring information at the second display position in the first map region. The second display position and the first display position do not overlap each other.

The region information may be description information of the corresponding map region, such as value information of the region in the virtual game scene. The first display position is a position in the corresponding map region for displaying region information, which may be allocated by a game application running in the terminal device when the virtual map is generated, or may be configured by a corresponding player, which is not limit thereto in this embodiment.

In this embodiment, the terminal device can determine the second display position corresponding to the target camp in the first map region based on the first display position of the corresponding region information in the first map region, so that the second display position and the first display position do not overlap each other, i.e., they are not blocked by each other. Then, the region to be colored for the target camp is rendered and displayed based on the coloring information at the second display position in the first map region.

For example, as shown in FIG. 3, in the map region 13A, if the region information corresponding to the map region 13A is displayed in the upper right corner of the map region 13A (such as the filled part in the upper right corner of the map region 13A in FIG. 3), the colored region of the target camp (such as the colored region 21 corresponding to the camp 11) may be displayed in the lower left corner of the map region 13A. If the corresponding region information is displayed in the upper left corner of the map region 13A, the colored region of the target camp (such as the colored region 21 corresponding to the camp 11) may be displayed in the lower right corner of the map region 13A. It can be understood that the second display position showing the colored region of the target camp and the first display position showing the region information do not overlap each other, so that the respective information is not blocked, and the specific position is not limited to the above example.

It should be understood that although the individual steps in the flow charts involved in the embodiments as described above are shown sequentially as indicated by arrows, the steps are not necessarily performed sequentially in the order indicated by the arrows. Unless explicitly stated herein, the execution of these steps is not strictly limited in any order and these steps can be performed in any other order. Moreover, at least some of the steps in the flow charts involved in the embodiments as described above may include multiple sub-steps or multiple stages that are not necessarily performed simultaneously, but may be performed at different moments. The order in which these sub-steps or stages are performed is not necessarily sequential, and these sub-steps or stages may be performed in turn or alternately with at least some of other steps or at least some of sub-steps or stages in other steps.

Based on the same inventive concept, embodiments of the present disclosure also provide a display control apparatus for a virtual map for implementing the display control method for a virtual map as described above. The solution to the problem provided by the apparatus is similar to the implementation of the method documented above, so the specific features in the one or more embodiments of the display control apparatus for a virtual map provided below may be understood with reference to the features of the display control method for a virtual map above and will not be repeated here.

In an exemplary embodiment, as shown in FIG. 11, a display control apparatus for a virtual map is provided, where the virtual map is configured with at least two camps and a plurality of map regions corresponding to a virtual game scene. The apparatus includes a coloring information determination module 1102, a region determination module 1104, and a rendering and display module 1106.

The coloring information determination module 1102 is configured to determine, upon receiving a configuration operation on a first map region in the virtual map, a target camp corresponding to the configuration operation, and obtain coloring information of the target camp.

The region determination module 1104 is configured to determine a region to be colored of the target camp in the first map region based on the configuration operation.

The rendering and display module 1106 is configured to render and display the region to be colored of the target camp in the first map region based on the coloring information.

In an exemplary embodiment, the configuration operation is configured to configure a virtual object to the first map region, and the region determination module is further configured to determine, after the configuration operation on the first map region in the virtual map is received, a number of historical accumulated virtual objects and a historical accumulated colored region corresponding to the historical configuration operation when it is determined that the target camp corresponding to the configuration operation has a historical configuration operation on the first map region. The rendering and display module is further configured to render and display the historical accumulated colored region and the region to be colored in the first map region based on the coloring information of the target camp when it is determined that the number of the historical accumulated virtual objects does not reach a preset number threshold.

In an exemplary embodiment, the rendering and display module is further configured to render and display the historical accumulated colored region in the first map region based on the coloring information of the target camp when it is determined that the number of the historical accumulated virtual objects reaches the preset number threshold.

In an exemplary embodiment, the rendering and display module is further configured to responds to an interactive operation on a second map region in the virtual map performed by at least one camp controlled by a user, the interaction operation being configured to obtain ownership of the second map region; determine a target camp that has the ownership of the second map region based on a result of the interactive operation; and render and display the second map region based on the coloring information corresponding to the target camp.

In an exemplary embodiment, the second map region includes a colored region corresponding to at least one camp. The rendering and display module is further configured to display a first attribute value of the camp corresponding to the colored region before responding to the interactive operation on the second map region in the virtual map performed by the at least one camp controlled by the user; determine and display a second attribute value of the camp based on the interactive operation; and when it is determined that the second attribute value of the camp is less than the corresponding first attribute value, decrease an area of the colored region corresponding to the camp.

In an exemplary embodiment, each of the map regions is displayed with corresponding region information. The rendering and display module is further configured to determine a first display position of the corresponding region information in the first map region; determine a second display position corresponding to the target camp in the first map region based on the first display position, the second display position and the first display position not overlapping each other; and render and display the region to be colored of the target camp based on the coloring information at the second display position in the first map region.

The individual modules in the above display control apparatus for a virtual map can be implemented in whole or in part by software, hardware or a combination thereof. Each of the above modules may be embedded in or independent of a processor in a computer device in a form of hardware, or may be stored in a memory in the computer device in a form of software, so as to be called by the processor to perform the operations corresponding to each of the above modules.

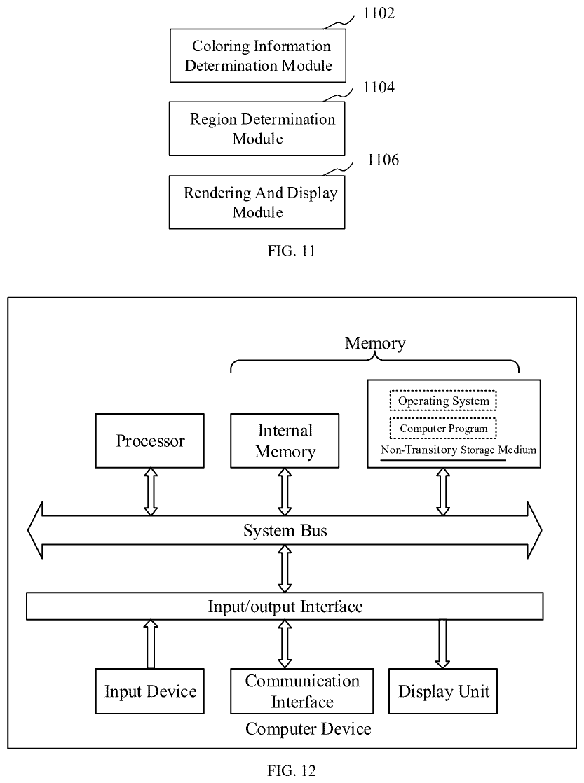

In an exemplary embodiment, a computer device is provided, which may be a terminal device, an internal configuration of which may be as shown in FIG. 12. The computer device includes a processor, a memory, an input/output interface, a communication interface, a display unit, and an input device. The processor, the memory and the input/output interface are connected via a system bus, and the communication interface, the display unit and the input device are connected to the system bus via the input/output interface. The processor of the computer device is configured to provide computing and control capabilities. The memory of the computer device includes a non-transitory storage medium and an internal memory. The non-transitory storage medium stores operating systems and computer programs. The internal memory provides an environment for the operation of the operating systems and the computer programs in the non-transitory storage medium. The input/output interface of the computer device is configured to exchange information between the processor and external devices. The communication interface of the computer device is configured to communicate with external terminals in wired or wireless mode, which can be realized by WIFI, mobile cellular network, near field communication (NFC) or other technologies. The computer programs are executed by the processor in order to implement a display control method for a virtual map. The display unit of the computer device is configured to form a visually visible picture, which may be a display screen, a projection device or a virtual reality imaging device. The display screen may be an LCD or e-ink display, and the input device of the computer device may be a touch layer covered by the display screen, or a key, trackball or trackpad set on the housing of the computer device, or an external keyboard, trackpad or mouse, etc.

It should be understood by a person of ordinary skill in the art that the structure illustrated in FIG. 12 is only a block diagram of part of the configuration related to the solution of the present disclosure, and does not constitute a limitation on the computer device to which the solution of the present disclosure is applied. Specifically, the computer device may include more or less components than those shown in the figure, or may combine some components, or may have a different arrangement of components.

In an exemplary embodiment, a computer device is provided, including a memory and a processor. A computer program is stored in the memory, and the processor implements the steps in each of the method embodiments described above when executing the computer program.

In an embodiment, a non-transitory computer-readable storage medium is provided, in which a computer program is stored. When the computer program is executed by a processor, the steps in the method embodiments described above are implemented.

In an embodiment, a computer program product is provided, including a computer program. When the computer program is executed by a processor, the steps in the method embodiments described above are implemented.

It should be noted that the user information (including but not limited to user device information, user personal information, etc.) and data (including but not limited to data used for analysis, stored data, displayed data, etc.) involved in the present disclosure are information and data authorized by the user or fully authorized by all parties, and the collection, use and processing of relevant data need to comply with relevant laws, regulations and standards of relevant countries and regions.

A person of ordinary skill in the art may understand that implementation of all or part of the processes in the methods of the above embodiments may be completed by instructing the relevant hardware through a computer program. The computer program may be stored in a non-transitory computer-readable storage medium. When the computer program is executed, it may include the processes of the respective methods according to the foregoing embodiments. Any reference to memory, database or other medium used of the embodiments provided in the present disclosure may include at least one of a non-transitory or a transitory memory. The non-transitory memory may include a read-only memory (ROM), a magnetic tape, a floppy disk, a flash memory, an optical memory, a high-density embedded non-transitory memory, a resistive random-access memory (ReRAM), a magneto resistive random-access memory (MRAM), a ferroelectric random-access memory (FRAM), a phase change memory (PCM), or a graphene memory, etc. The transitory memory may include a random-access memory (RAM) or an external cache memory, etc. As an illustration rather than a limitation, the random-access memory may be in various forms, such as a static random-access memory (SRAM) or a dynamic random-access memory (DRAM), etc. The databases involved in the embodiments provided by the present disclosure may include at least one of a relational database and a non-relational database. The non-relational database may include, but is not limited to, a blockchain-based distributed database, etc. The processor involved in the embodiments provided by the present disclosure may be, but is not limited to, a general purpose processor, a central processor, a graphics processor, a digital signal processor, a programmable logic device, a data processing logic device based on quantum computation, an artificial intelligence (AI) processor, and the like.

The technical features in the above embodiments may be combined arbitrarily. For concise description, not all possible combinations of the technical features in the above embodiments are described. However, provided that they do not conflict with each other, all combinations of the technical features are to be considered to be within the scope of protection of the present disclosure.

The above-mentioned embodiments only describe several implementations of the present disclosure, and their description is specific and detailed, but should not be understood as a limitation on the protection scope of the present disclosure. It should be noted that, for a person of ordinary skill in the art, various variations and improvements can be further made without departing from the conception of the present disclosure, and these all fall within the protection scope of the present disclosure. Therefore, the protection scope of the present disclosure should be subject to the appended claims.

1. A display control method for a virtual map, wherein the virtual map is configured with at least two camps and a plurality of map regions corresponding to a virtual game scene, and the method comprises:
upon receiving a configuration operation on a first map region in the virtual map, determining a target camp corresponding to the configuration operation, and obtaining coloring information of the target camp;
determining a region to be colored of the target camp in the first map region based on the configuration operation;
rendering and displaying the region to be colored of the target camp in the first map region based on the coloring information;
wherein the configuration operation is configured to configure a virtual object to the first map region, and after the configuration operation on the first map region in the virtual map is received, the method further comprises:
when it is determined that the target camp corresponding to the configuration operation has a historical configuration operation on the first map region, determining a number of historical accumulated virtual objects and a historical accumulated colored region corresponding to the historical configuration operation; and
wherein rendering and displaying the region to be colored of the target camp in the first map region based on the coloring information comprises:
when it is determined that the number of the historical accumulated virtual objects does not reach a preset number threshold, rendering and displaying the historical accumulated colored region and the region to be colored in the first map region based on the coloring information of the target camp; and
when it is determined that the number of the historical accumulated virtual objects reaches the preset number threshold, rendering and displaying the historical accumulated colored region in the first map region based on the coloring information of the target camp.

2-3. (canceled)

4. The method of claim 1, wherein the method further comprises:
responding to an interactive operation on a second map region in the virtual map performed by at least one camp controlled by a user, the interaction operation being configured to obtain ownership of the second map region;
determining a target camp that has ownership of the second map region based on a result of the interactive operation; and
rendering and displaying the second map region based on the coloring information corresponding to the target camp.

5. The method of claim 4, wherein the second map region comprises a colored region corresponding to at least one camp, and before responding to the interactive operation on the second map region in the virtual map performed by the at least one camp controlled by the user, the method further comprises:
displaying a first attribute value of the camp corresponding to the colored region; and
wherein after responding to the interactive operation on the second map region in the virtual map performed by the at least one camp controlled by the user, the method further comprises:
determining and displaying a second attribute value of the camp based on the interactive operation; and
when it is determined that the second attribute value of the camp is less than the corresponding first attribute value, decreasing an area of the colored region corresponding to the camp.

6. The method of claim 1, wherein each of the map regions is displayed with corresponding region information, and rendering and displaying the region to be colored of the target camp in the first map region based on the coloring information comprises:
determining a first display position of the corresponding region information in the first map region;
determining a second display position corresponding to the target camp in the first map region based on the first display position, the second display position and the first display position not overlapping each other; and
rendering and displaying the region to be colored of the target camp based on the coloring information at the second display position in the first map region.

7. (canceled)

8. A computer device comprising a memory and a processor, the memory storing a computer program, wherein the processor, when executing the computer program, implements steps of the method of claim 1.

9. A non-transitory computer-readable storage medium having a computer program stored thereon, wherein when the computer program is executed by a processor, steps of the method of claim 1 are implemented.

10. A computer program product comprising a computer program, wherein when the computer program is executed by a processor, steps of the method of claim 1 are implemented.
